(19) United States
(12) Patent Application Publication
(10) Pub. No.: US 2024/0025038 A1
(43) Pub. Date: Jan. 25, 2024

(54) ROBOT CONTROL METHOD, LEGGED ROBOT USING THE SAME, AND COMPUTER-READABLE STORAGE MEDIUM

(71) Applicant: UBTECH ROBOTICS CORP LTD, Shenzhen (CN)

(72) Inventors: Yisen HU, Shenzhen (CN); Hao Dong, Shenzhen (CN); Hongyu Ding, Shenzhen (CN); Youjun Xiong, Shenzhen (CN)

(21) Appl. No.: 18/373,991

(22) Filed: Sep. 28, 2023

Related U.S. Application Data
(63) Continuation of application No. PCT/CN2021/125045, filed on Oct. 20, 2021.

(30) Foreign Application Priority Data
Mar. 29, 2021 (CN) 202110334669.4

(51) Int. Cl. B25J 9/16; B25J 9/10; B62D 57/032

(52) U.S. Cl. CPC B25J 9/163; B25J 9/1664; B25J 9/106; B25J 9/161; B25J 9/1607; B62D 57/032

(57) ABSTRACT

A robot control method, a legged robot using the same, and a computer-readable storage medium are provided. The method includes: obtaining a motion parameter of a driving mechanism of a target part of the robot; and obtaining an end pose of the target part by processing the motion parameter of the driving mechanism according to a preset forward kinematics solving model, where the forward kinematics solving model is a neural network model trained by a preset training sample set constructed according to a preset inverse kinematics function relationship. In this manner, a complex forward kinematics solving process can be transformed into a relatively simple inverse kinematics solving process and neural network model processing process, which reduces the computational complexity, shortens the computational time, thereby meeting the demand for real-time control of the robot.

### CROSS REFERENCE TO RELATED APPLICATIONS

The present disclosure is a continuation-application of International Application PCT/CN2021/125045, with an international filing date of Oct. 20, 2021, which claims foreign priority of Chinese Patent Application No. 202110334669.4, filed on Mar. 29, 2021 in the State Intellectual Property Office of China, the contents of all of which are hereby incorporated by reference.

### BACKGROUND

### 1. Technical Field

The present disclosure relates to robot technology, and particularly to a robot control method, a legged robot using the same, and a computer-readable storage medium.

### 2. Description of Related Art

In the gait control of a biped robot, kinematics solving including forward kinematics solving and inverse kinematics solving that are to be performed on its legs is essential. Forward kinematics refers to the process of calculating the end pose from the joint angle, and inverse kinematics refers to the process of inferring the joint angle from the end pose. Forward kinematics is mainly used to estimate the current posture of the robot to perform necessary algorithmic compensation, thereby ensuring the stability of the robot. Inverse kinematics is mainly used to calculate joint angles after motion trajectory planning, thereby ensuring the robot to move according to the planned trajectory. For a parallel mechanism, it will relatively easy to directly derive the analytical solution of inverse kinematics through the configuration. However, for forward kinematics, the derivation of the analytical solution will result in a system of high-order equations which is difficult to solve. Therefore, the forward kinematics of the parallel configuration is generally calculated using numerical methods that are based on the Jacobian matrix and iteratively approximated by the Newton-Raphson method. However, the method has high computational complexity which takes a long time, and is difficult to meet the real-time control requirement of the robot.

### BRIEF DESCRIPTION OF THE DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments. For those skilled in the art, other drawings can be obtained according to the drawings without creative efforts.

FIG. 1 is a flow chart of a process of training a forward kinematics solving model according to an embodiment of the present disclosure.

FIG. 2 is a schematic diagram of a link transmission mechanism according to an embodiment of the present disclosure.

FIG. 3 is a schematic diagram of a simplified model of the link transmission mechanism of FIG. 2.

FIG. 4 is a flow chart of a robot forward kinematics solving method according to an embodiment of the present disclosure.

FIG. 5 is a schematic diagram of a forward kinematics solving model according to an embodiment of the present disclosure.

FIG. 6 is a schematic diagram of the structure of a robot forward kinematics solving apparatus according to an embodiment of the present disclosure.

FIG. 7 is a schematic block diagram of a robot according to an embodiment of the present disclosure.

### DETAILED DESCRIPTION

In order to make the objects, features and advantages of the present disclosure more obvious and easy to understand, the technical solutions in the embodiments of the present disclosure will be clearly and completely described below with reference to the drawings. Apparently, the described embodiments are part of the embodiments of the present disclosure, not all of the embodiments. All other embodiments obtained by those skilled in the art based on the embodiments of the present disclosure without creative efforts are within the scope of the present disclosure.

It is to be understood that, when used in the description and the appended claims of the present disclosure, the terms “including” and “comprising” indicate the presence of stated features, integers, steps, operations, elements and/or components, but do not preclude the presence or addition of one or a plurality of other features, integers, steps, operations, elements, components and/or combinations thereof.

It is also to be understood that, the terminology used in the description of the present disclosure is only for the purpose of describing particular embodiments and is not intended to limit the present disclosure. As used in the description and the appended claims of the present disclosure, the singular forms “one”, “a”, and “the” are intended to include the plural forms as well, unless the context clearly indicates otherwise.

It is also to be further understood that the term “and/or” used in the description and the appended claims of the present disclosure refers to any combination of one or more of the associated listed items and all possible combinations, and includes such combinations.

As used in the description and the appended claims, the term “if” may be interpreted as “when” or “once” or “in response to determining” or “in response to detecting” according to the context. Similarly, the phrase “if determined” or “if [the described condition or event] is detected” may be interpreted as “once determining” or “in response to determining” or “on detection of [the described condition or event]” or “in response to detecting [the described condition or event]”.

In addition, in the present disclosure, the terms “first”, “second”, “third”, and the like in the descriptions are only used for distinguishing, and cannot be understood as indicating or implying relative importance.

In the present disclosure, a complex robot forward kinematics solving process is transformed into a relatively simple inverse kinematics solving process and neural network model processing process. That is, a sufficient number of training samples are generated through inverse kinematics solution, where the output of inverse kinematics is used as the input and the input of inverse kinematics is used as the expected output, thereby training the neural network model used for forward kinematics solving, that is, the forward kinematics solving model.

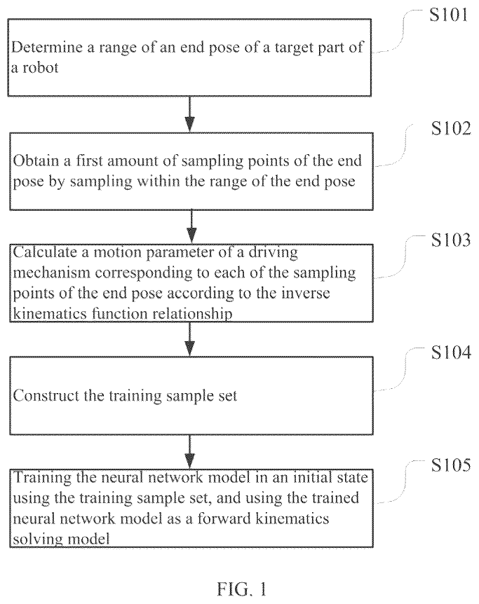

FIG. 1 is a flow chart of a process of training a forward kinematics solving model according to an embodiment of the present disclosure. As shown in FIG. 1, the training process of the forward kinematics solving model may include the following steps.

S101: determining a range of an end pose of a target part of a robot.

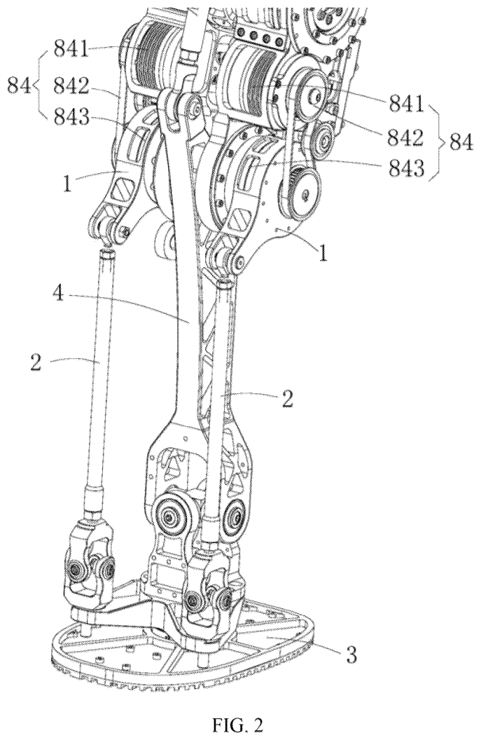

In this embodiment, the robot may be a biped robot, and the target part may be a part of the robot to perform forward kinematics solving, for example, a link transmission mechanism shown in FIG. 2. Different parts of the robot may be selected as the target part according to actual needs. It should be noted that different parts of the robot have different ranges of the end pose, which need to be changed according to actual needs. In which, the end pose is the pose of an end (e.g., a second rotation arm 3 shown in FIG. 2) of the robot. In other embodiments, the robot may be other kind of legged robot.

S102: obtaining a first amount of sampling points of the end pose by sampling within the range of the end pose.

The specific value of the first amount may be set according to actual needs. Generally, in order to ensure the accuracy of the trained model, sampling points should be collected as much as possible, so the first amount may be set to, for example, 100,000, 500,000, 1,000,000, or the like.

During sampling, different sampling methods such as random sampling, uniform sampling, and weighted sampling may be adopted according to actual needs.

Random sampling means randomly selecting sampling points in the range of the end pose.

Uniform sampling selects sampling points evenly in the range of the end pose. For example, if the end of the target part has two motion dimensions, namely rotating around a preset first coordinate axis (e.g., the x-axis) and rotating around a preset second coordinate axis (e.g., the y-axis), where the posture angle of rotating around the first coordinate axis is [θₒₓ₋ₘᵢₙ, θₒₓ₋ₘₐₓ] and that of rotating around the second coordinate axis is [θₒₓ₋ₘᵢₙ, θₒₓ₋ₘₐₓ], then M values within the range of [θₒₓ₋ₘᵢₙ, θₒₓ₋ₘₐₓ] may be selected at equal intervals and M values within the range of [θₒₓ₋ₘᵢₙ, θₒₓ₋ₘₐₓ] may also be selected at equal intervals, and then a total M2 sampling points can be formed by combining the two, where M2 is larger than or equal to the first amount.

Weighted sampling divides the entire range of the end pose into a plurality of sub-ranges, where different weights are set for each sub-range according to actual needs. The density of sampling points in each sub-range is positively related to its weight, that is, the greater the weight, the larger the density of sampling points; otherwise, the smaller the weight, and the smaller the density of sampling points. For each sub-range, random sampling or uniform sampling may be according to actual needs.

S103: calculating the motion parameter of the driving mechanism corresponding to each of the sampling points of the end pose according to the preset inverse kinematics function relationship.

For different target parts, their inverse kinematics function relationships are also different, and they need to be set according to actual needs. The inverse kinematics function relationship takes the end pose of the target part as input and the motion parameter of the corresponding driving mechanism as output.

FIG. 2 is a schematic diagram of the link transmission mechanism according to an embodiment of the present disclosure. As shown in FIG. 2, in order to facilitate understanding, the inverse kinematics analysis process will be described in detail by taking the link transmission mechanism as the target part. The link transmission mechanism may include a first rotation arm 4, a swing member 1 driven by a first driving mechanism 84, a first link member 2, and a second rotation arm 3; two ends of the swing member 1 are rotatably connected to the first rotation arm 4 and the first link member 2, respectively, and an end of the first rotation arm 4 away from the swing member 1 and an end of the first link member 2 away from the swing member 1 are both movably connected to the second rotation arm 3. For other details about the link transmission mechanism, please refer to the Chinese invention patent application of number 202010876250.7, which will not be described herein. For the link transmission mechanism, the motion parameter of the driving mechanism is a driving angle of the first driving mechanism 84, and the end pose is a posture angle of the second rotation arm 3.

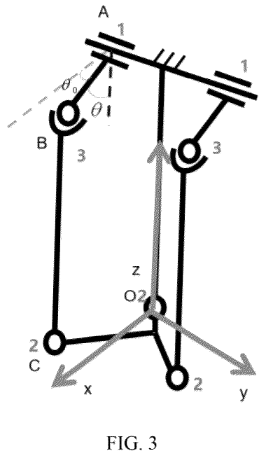

FIG. 3 is a schematic diagram of a simplified model of the link transmission mechanism of FIG. 2. As shown in FIG. 3, A is a connection point between the first driving mechanism 84 and the swing member 1, B is a connection point between the first link member 2 and the swing member 1, and C is a connection point between the first link member 2 and the second rotation arm 3, O is a connection point between the first rotation arm 4 and the second rotation arm 3, that is, a ankle joint of the robot. The swing member 1 may be equivalent to link AB, and the first link member 2 may be equivalent to link BC. It should be noted that the connection points mentioned herein are not physical connection points, but virtual connection points in the model.

A Cartesian coordinate system is established with O as the origin of coordinate, where the x-axis points to the movement direction of the robot, the y-axis points to the inner side of the robot, and the z-axis is in vertical direction. The two first driving mechanisms 84 control the joint O to rotate around the x-axis and the y-axis through the same link mechanism ABCO, that is, the second rotation arm 3 is controlled to rotate around the x-axis and the y-axis. In this coordinate system, the position vectors of A, B, and C may be expressed as equations of:

\vec{r_{A}}=\vec{r_{A0}};

\vec{r_{B}}=\vec{r_{A}}+R_{y}(θ)(\vec{r_{B0}}−\vec{r_{A0}}); and

\vec{r_{C}}=R_{y}(θ_{oy})Rₓ(θₒₓ)\vec{r_{C0}};
where, \vec{r_{A}} is a position vector of point A, \vec{r_{B}} is a position vector of point B, and \vec{r_{C}} is a position vector of point C; θₒₓ is a posture angle of the second rotation arm 3 around the x-axis, and θ_{oy} is a posture angle of the second rotation arm 3 around the y-axis; Rₓ(θₒₓ) is a corresponding rotation matrix of rotating around the x-axis, where R_{y}(θ_{oy}) is a corresponding rotation matrix of rotating around the y-axis, θ is a driving angle of the first driving mechanism 84, that is, the angle at which the first driving mechanism 84 drives the swing member 1 to rotate; R_{y}(θ) is a corresponding rotation matrix of rotating around the y-axis; and \vec{r_{A0}} is an initial position vector of the point A, \vec{r_{B0}} is an initial position vector of the point B, and \vec{r_{C0}} is an initial position vector of the point C. Assuming that in an initial state, an initial included angle between the swing member 1 and the horizontal plane is θ₀, the corresponding position vectors of A, B, and C are the initial position vectors.

Based on the above-mentioned equations, it may be calculated as an equation of:

∥\vec{r_{C}}−\vec{r_{B}}∥²−∥\vec{r_{C}}−\vec{r_{A}}∥²−∥\vec{r_{B}}−\vec{r_{A}}∥²=2[(x_{A}−x_{C})(x_{B0}−x_{A0})+(z_{A}−z_{C})(z_{B0}−z_{A0})]cos(θ)+2[(x_{A}−x_{C})(z_{B0}−z_{A0})+(z_{A}−z_{C})(x_{B0}−x_{A0})]sin(θ);
where, x_{A} is a coordinate component of point A on the x-axis, z_{A} is a coordinate component of point A on the z-axis, x_{C} is a coordinate component of point C on the x-axis, z_{C} is a coordinate component of point C on the z-axis, x_{A0} is a coordinate component of point A on the x-axis in the initial state, z_{A0} is a coordinate component of point A on the z-axis in the initial state, x_{B0} is a coordinate component of point B on the x-axis in the initial state, z_{B0} is a coordinate component of point B on the z-axis in the initial state.

Since the lengths of links AB and BC are fixed, it may get equations of:

∥\vec{r_{B}}−\vec{r_{A}}∥²=l_{AB}; and

∥\vec{r_{C}}−\vec{r_{B}}∥²=l_{BC};
where, l_{AB} is the length from point A to point B, and l_{BC} is the length from point B to point C.

Based on this, it may be inferred that the inverse kinematics functional relationship is as equations of:

$$θ = arcsin ( \frac{bc + \sqrt{{b}^{2} {c}^{2} - ( {a}^{2} + {b}^{2} ) ( {c}^{2} - {a}^{2} )}}{{a}^{2} + {b}^{2}} ) + {θ}_{0} ;$$

$$a = {x}_{A} - {x}_{C} ;$$

$$b = {z}_{A} - {z}_{C} ;$$

$$and c = \frac{{l}_{BC}^{2} - {l}_{AB}^{2} - {‖ {R}_{y} ( {θ}_{oy} ) {R}_{x} ( {θ}_{ox} ) \vec{{r}_{C 0}} - \vec{{r}_{A 0}} ‖}^{2}}{2 {l}_{AB}} .$$

Based on this functional relationship, the driving angle of the first driving mechanism 84 may be calculated through the posture angle of the joint O (i.e., the posture angle of the second rotation arm 3). It should be noted that there are two first driving mechanisms 84 in the link transmission mechanism. The forgoing process has explained by taking the first driving mechanism 84 on the left part of FIG. 2 as an example, and the process for the first driving mechanism 84 on the right part of FIG. 2 is similar and will not be described herein. As an example, to facilitate the distinction, the driving angle of the first driving mechanism 84 on the left part and that of the first driving mechanism 84 on the right part may be denoted as θ₁ and θ₂, respectively.

S104: constructing the preset training sample set.

The training sample set may include the first amount of training samples, each of the training samples may include a set of the sampling points of the end pose and the corresponding motion parameters of the driving mechanism.

S105: training the neural network model in an initial state using the preset training sample set, and using the trained neural network model as the forward kinematics solving model.

The type of neural network model used can be selected according to actual needs, which may include convolutional neural networks (CNN), deep convolutional neural network (DCNN), reverse graph network (IGN), generative adversarial network (GAN), recurrent neural network (RNN), deep residual network (DRN), support vector machine (SVM), and other neural network models.

In this embodiment, the neural network model uses the output of inverse kinematics as the input and the input of inverse kinematics as the expected output. During training, for each training sample in the training sample set, the neural network model may be used to process the motion parameters of the driving mechanism in the training sample to obtain the actual output end pose, and then calculate the training loss value based on the expected output end pose in the training sample and the actual output end pose. The specific calculation method of the training loss value may be set according to actual needs. For example, the squared error between the expected output end pose and the actual output end pose may be calculated to determine as the training loss value.

After the training loss value is calculated, the model parameters of the neural network model may be adjusted based on the training loss value. In this embodiment, it is assumed that the initial model parameter of the neural network model is W1, and the training loss value is back-propagated to modify the model parameter W1 of the neural network model so as to obtain the modified model parameter W2. After modifying the parameter, it continues to perform the next training process. During the training, the training loss value is recalculated to back-propagate to modify the model parameter W2 of the neural network model so to obtain the modified model parameter W3, . . . , and so on. The forgoing process is repeated continuously to modify the model parameters in each training process until a preset training condition is met. The training condition may be that the times of training reaches a preset threshold. The threshold may be set according to actual needs, for example, set to thousands, tens of thousands, hundreds of thousands, or even larger values. The training condition may also be that the convergence of the neural network model. In addition, there may be a case that the times of training not reaches the threshold but the neural network model has converged which may cause unnecessary work to be repeated; or another case that the neural network model never converges which may cause an infinite loop and fail to end the training process. For the forgoing two cases, the training condition may also be that the times of training reaches the preset threshold or the neural network model converges. When the training conditions are met, the trained forward kinematics solving model can be obtained.

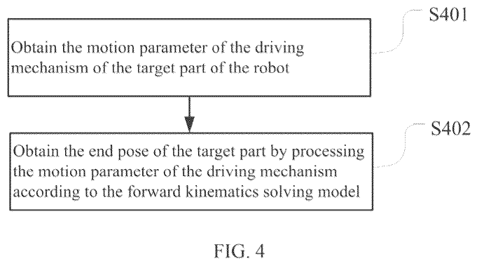

FIG. 4 is a flow chart of a robot forward kinematics solving method according to an embodiment of the present disclosure. As shown in FIG. 4, after the forward kinematics solving model is obtained through training, the forward kinematics solving of the robot may include the following steps.

S401: obtaining a motion parameter of a driving mechanism of a target part of the robot.

S402: obtaining an end pose of the target part by processing the motion parameter of the driving mechanism according to a preset forward kinematics solving model.

The target part (e.g., an end such as a gripper) of the robot may be controlled to move based on the obtained end pose, that is, the estimated current pose of the target part, so as to, for example, compensate the difference between the estimated current pose and a desired pose of the target part. In one embodiment, the motion parameter of the driving mechanism may be directly input into the forward kinematics solving model for processing to produce an output, and the output may be used as the end pose of the target part.

In another embodiment, the forward kinematics solving model may be converted into a matrix expression first, and then the motion parameter of the driving mechanism may be substituted into the matrix expression for calculation to obtain an operation result, and the operation result may be used as the end pose of the target part.

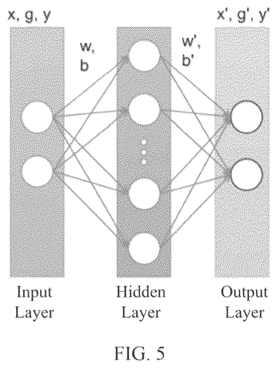

FIG. 5 is a schematic diagram of a forward kinematics solving model according to an embodiment of the present disclosure. As shown in FIG. 5, for ease of understanding, the forward kinematics solving model is taken as an example to describe in detail the process of converting the forward kinematics solving model into a matrix expression. The forward kinematics solving model may include an input layer, a hidden layer, and an output layer.

In one embodiment, a processing process of the input layer may be converted into the matrix expression as an equation of:

A_{P×1}=[a₁a₂ . . . aₚ . . . a_{P}]^{T}, aₚ=(θₚ+xₚ)×gₚ−yₚ;
where, p is a sequence number of the motion parameter of the driving mechanism, 1≤p≤P, P is an amount of the motion parameters of the driving mechanism and its specific value may be set according to actual needs, for example, in the example corresponding to FIG. 2, P is 2, θₚ is the p-th motion parameter of the driving mechanism, and xₚ, gₚ, and yₚ are processing parameters of the input layer in the positive kinematics solving model that correspond to the motion parameter θₚ, where these parameters will be all known quantities after the model training is completed; the aₚ is a processing result of the input layer that corresponds to the motion parameter θₚ; and A_{P×1} are processing results of the input layer.

In one embodiment, a processing process from the input layer to the hidden layer may be converted into the matrix expression as an equation of:

C_{N×1}=B_{N×1}+W_{N×P}·A_{P×1};
where, N is an amount of neurons in the hidden layer, W_{N×P} is a first weight matrix in the forward kinematics solving model, B_{N×1} is a first bias matrix in the forward kinematics solving model, and C_{N×1} is a processing result from the input layer to the hidden layer.

In one embodiment, a processing process of the hidden layer may be converted into the matrix expression as an equation of:

$${D}_{N \times 1} = \frac{2}{[ 1 + exp ( - 2 \times {C}_{N \times 1} ) ]} - 1 ;$$

where exp is a natural exponential function, and D_{N×1} is a processing result of the hidden layer.

In one embodiment, a processing process from the hidden layer to the output layer may be converted into the matrix expression as an equation of:

E_{Q×1}=B′_{Q×1}+W′_{Q×N}·D_{N×1}=[e₁e₂ . . . e_{q} . . . e_{Q}]^{T};
where, q is a parameter sequence number of the end pose, 1≤q≤Q, Q is a parameter amount of the end pose and its specific value may be set according to actual needs, for example, in the example corresponding to FIG. 2, Q is 2, W′_{Q×N} is a second weight matrix in the forward kinematics solving model, and B′_{Q×1} is a second bias matrix in the forward kinematics solving model, where these parameters will be all known quantities after the model training is completed: W_{Q×1} is a processing result from the hidden layer to the output layer, and e_{q} is the q-th element in the processing result E_{Q×1}.

In one embodiment, a processing process of the output layer may be converted into the matrix expression as an equation of:

$${F}_{Q \times 1} = {[ {θ}_{o 1} {θ}_{o 2} … {θ}_{oq} … {θ}_{oQ} ]}^{T} , {θ}_{oq} = \frac{( {e}_{q} - {y}_{q}^{′} )}{{g}_{q}^{′}} + {x}_{q}^{′} ;$$

where, θ_{oq} is the q-th parameter of the end pose, x′_{q}, g′_{q}, and y′_{q} are processing parameters of the output layer in the positive kinematics solving model that correspond to the parameter θ_{oq}, where these parameters will be all known quantities after the model training is completed; and F_{Q×1} is a processing result of the output layer.

It should be noted that the above-mentioned conversion process is only an example. For different forward kinematics solving models, it may be converted into corresponding matrix expressions according to actual needs, which will not be described herein.

To sum up, in the embodiments of the present disclosure, by obtaining a motion parameter of a driving mechanism of a target part of the robot; and obtaining an end pose of the target part by processing the motion parameter of the driving mechanism according to a preset forward kinematics solving model, where the forward kinematics solving model is a neural network model trained by a preset training sample set constructed according to a preset inverse kinematics function relationship, a complex forward kinematics solving process can be transformed into a relatively simple inverse kinematics solving process and neural network model processing process, which reduces the computational complexity, shortens the computational time, thereby meeting the demand for real-time control of the robot.

It should be understood that, the sequence of the serial number of the steps in the above-mentioned embodiments does not mean the execution order while the execution order of each process should be determined by its function and internal logic, which should not be taken as any limitation to the implementation process of the embodiments.

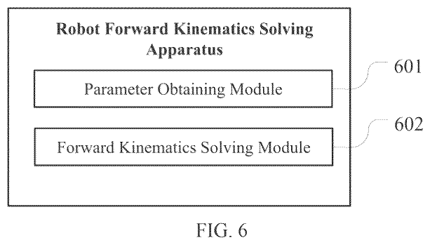

FIG. 6 is a schematic diagram of the structure of a robot forward kinematics solving apparatus according to an embodiment of the present disclosure. As shown in FIG. 6, a forward kinematics solving apparatus for the robot that corresponds to the robot forward kinematics solving method described in the above-mentioned embodiment is provided.

In this embodiment, the robot forward kinematics solving apparatus may include:
a parameter obtaining module 601 configured to obtain a motion parameter of a driving mechanism of a target part of the robot, where the motion parameter of the driving mechanism is a driving angle of the driving mechanism of the target part; and
a forward kinematics solving module 602 configured to obtain an end pose of the target part by processing the motion parameter of the driving mechanism according to a preset forward kinematics solving model, where the end pose is a posture angle of a rotation arm of the target part, and the forward kinematics solving model is a neural network model trained by a preset training sample set constructed according to a preset inverse kinematics function relationship.

Furthermore, the robot forward kinematics solving apparatus may further include:
an end pose range determining module configured to determine a range of the end pose of the target part;
a sampling module configured to obtain a first amount of sampling points of the end pose by sampling within the range of the end pose;
an inverse kinematics calculation module configured to calculate the motion parameter of the driving mechanism corresponding to each of the sampling points of the end pose according to the preset inverse kinematics function relationship;
a training sample set constructing module configured to construct the preset training sample set, where the training sample set includes the first amount of training samples, each of the training samples includes a set of the sampling points of the end pose and the corresponding motion parameters of the driving mechanism; and
a model training module configured to train the neural network model in an initial state using the preset training sample set, and using the trained neural network model as the forward kinematics solving model.

Furthermore, the forward kinematics solving module 602 may include:
a model processing unit configured to input the motion parameter of the driving mechanism into the forward kinematics solving model for processing to produce an output, and use the output as the end pose of the target part

Furthermore, the forward kinematics solving module 602 may include:
a model converting unit configured to convert the forward kinematics solving model into a matrix expression; and
a matrix operating unit configured to substitute the motion parameter of the driving mechanism into the matrix expression for calculation to obtain an operation result, and using the operation result as the end pose of the target part.

Furthermore, the target part may be a link transmission mechanism which may include a first rotation arm, a swing member driven by a first driving mechanism, a first link member, and a second rotation arm; two ends of the swing member are rotatably connected to the first rotation arm and the first link member, respectively, and an end of the first rotation arm away from the swing member and an end of the first link member away from the swing member are both movably connected to the second rotation arm; the motion parameter of the driving mechanism is a driving angle of the first driving mechanism; and the end pose is a posture angle of the second rotation arm.

Those skilled in the art may clearly understand that, for the convenience and simplicity of description, for the specific operation process of the above-mentioned apparatus, modules and units, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

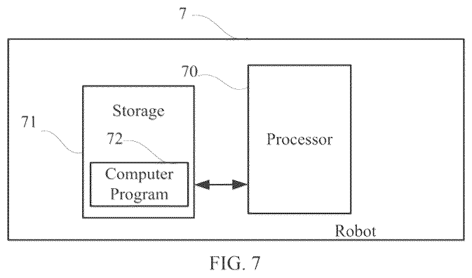

FIG. 7 is a schematic block diagram of a robot according to an embodiment of the present disclosure. For convenience of description, only parts related to this embodiment are shown.

As shown in FIG. 7, in this embodiment, the robot 7 includes a processor 70, a storage 71, and a computer program 72 stored in the storage 71 and executable on the processor 70. When executing (instructions in) the computer program 72, the processor 70 implements the steps in the above-mentioned embodiments of the robot forward kinematics solving method, for example, steps S401-S402 shown in FIG. 4. Alternatively, when the processor 70 executes the (instructions in) computer program 72, the functions of each module/unit in the above-mentioned device embodiments, for example, the functions of the modules 601-602 shown in FIG. 6 are implemented.

Exemplarily, the computer program 72 may be divided into one or more modules/units, and the one or more modules/units are stored in the storage 71 and executed by the processor 70 to realize the present disclosure. The one or more modules/units may be a series of computer program instruction sections capable of performing a specific function, and the instruction sections are for describing the execution process of the computer program 72 in the robot 7.

The robot 7 may be a computing device such as a desktop computer, a notebook computer, a tablet computer, and a cloud server. The robot 7 may include, but is not limited to, the processor 70 and the storage 71. It can be understood by those skilled in the art that FIG. 7 is merely an example of the robot 7 and does not constitute a limitation on the robot 7, and may include more or fewer components than those shown in the figure, or a combination of some components or different components. For example, the robot 7 may further include an input/output device, a network access device, a bus, and the like.

The processor 70 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 71 may be an internal storage unit of the robot 7, for example, a hard disk or a memory of the robot 7. The storage 71 may also be an external storage device of the robot 7, for example, a plug-in hard disk, a smart media card (SMC), a secure digital (SD) card, flash card, and the like, which is equipped on the robot 7. Furthermore, the storage 71 may further include both an internal storage unit and an external storage device, of the robot 7. The storage 71 is configured to store the computer program 72 and other programs and data required by the robot 7. The storage 71 may also be used to temporarily store data that has been or will be output.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/robot and method may be implemented in other manners. For example, the above-mentioned apparatus/robot embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer readable storage medium. Based on this understanding, all or part of the processes in the method for implementing the above-mentioned embodiments of the present disclosure are implemented, and may also be implemented by instructing relevant hardware through a computer program. The computer program may be stored in a non-transitory computer readable storage medium, which may implement the steps of each of the above-mentioned method embodiments when executed by a processor. In which, the computer program includes computer program codes which may be the form of source codes, object codes, executable files, certain intermediate, and the like. The computer readable medium may include any entity or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A computer-implemented control method for a legged robot, comprising:
obtaining a motion parameter of a driving mechanism of a target part of the robot, wherein the motion parameter of the driving mechanism is a driving angle of the driving mechanism of the target part;
obtaining an end pose of the target part by processing the motion parameter of the driving mechanism according to a preset forward kinematics solving model, wherein the end pose is a posture angle of a rotation arm of the target part, and the forward kinematics solving model is a neural network model trained by a preset training sample set constructed according to a preset inverse kinematics function relationship; and
controlling the target part of the robot to move based on the end pose.

2. The method of claim 1, wherein the forward kinematics solving model is trained by:
determining a range of the end pose of the target part;
obtaining a first amount of sampling points of the end pose by sampling within the range of the end pose;
calculating the motion parameter of the driving mechanism corresponding to each of the sampling points of the end pose according to the preset inverse kinematics function relationship;
constructing the preset training sample set, wherein the training sample set includes the first amount of training samples, each of the training samples includes a set of the sampling points of the end pose and the corresponding motion parameters of the driving mechanism; and
training the neural network model in an initial state using the preset training sample set, and using the trained neural network model as the forward kinematics solving model.

3. The method of claim 1, wherein obtaining the end pose of the target part by processing the motion parameter of the driving mechanism according to the preset forward kinematics solving model comprises:
inputting the motion parameter of the driving mechanism into the forward kinematics solving model for processing to produce an output, and using the output as the end pose of the target part.

4. The method of claim 1, wherein obtaining the end pose of the target part by processing the motion parameter of the driving mechanism according to the preset forward kinematics solving model comprises:
converting the forward kinematics solving model into a matrix expression; and
substituting the motion parameter of the driving mechanism into the matrix expression for calculation to obtain an operation result, and using the operation result as the end pose of the target part.

5. The method of claim 4, wherein the forward kinematics solving model includes an input layer, a hidden layer, and an output layer; converting the forward kinematics solving model into the matrix expression comprises:
converting a processing process of the input layer into the matrix expression as an equation of:
A_{P×1}=[a₁a₂ . . . aₚ . . . a_{P}]^{T}, aₚ=(θₚ+xₚ)×gₚ−yₚ;
where, p is a sequence number of the motion parameter of the driving mechanism, 1≤p≤P, P is an amount of the motion parameters of the driving mechanism, θₚ is the p-th motion parameter of the driving mechanism, xₚ, gₚ, and yₚ are processing parameters of the input layer in the positive kinematics solving model that correspond to the motion parameter θₚ, the aₚ is a processing result of the input layer that corresponds to the motion parameter θₚ, and A_{P×1} are processing results of the input layer;
converting a processing process from the input layer to the hidden layer into the matrix expression as an equation of:
C_{N×1}=B_{N×1}+W_{N×P}·A_{P×1};
where, N is an amount of neurons in the hidden layer, W_{N×P} is a first weight matrix in the forward kinematics solving model, B_{N×1} is a first bias matrix in the forward kinematics solving model, and CV, is a processing result from the input layer to the hidden layer;
converting a processing process of the hidden layer into the matrix expression as an equation of:
$${D}_{N \times 1} = \frac{2}{[ 1 + exp ( - 2 \times {C}_{N \times 1} ) ]} - 1 ;$$
where exp is a natural exponential function, and D_{N×1} is a processing result of the hidden layer;
converting a processing process from the hidden layer to the output layer into the matrix expression as an equation of:
E_{Q×1}=B′_{Q×1}+W′_{Q×N}·D_{N×1}=[e₁e₂ . . . e_{q} . . . e_{Q}]^{T};
where, q is a parameter sequence number of the end pose, 1≤q≤Q, Q is a parameter amount of the end pose, W′_{Q×N} is a second weight matrix in the forward kinematics solving model, B′_{Q×1} is a second bias matrix in the forward kinematics solving model, E_{Q×1} is a processing result from the hidden layer to the output layer, and e_{q} is the q-th element in the processing result E_{Q×1}; and
converting a processing process of the output layer into the matrix expression as an equation of:
$${F}_{Q \times 1} = {[ {θ}_{o 1} {θ}_{o 2} … {θ}_{oq} … {θ}_{oQ} ]}^{T} , {θ}_{oq} = \frac{( {e}_{q} - {y}_{q}^{′} )}{{g}_{q}^{′}} + {x}_{q}^{′} ;$$
where, θ_{oq} is the q-th parameter of the end pose, x′_{q}, g′_{q}, and y′_{q} are processing parameters of the output layer in the positive kinematics solving model that correspond to the parameter θ_{oq}, and F_{Q×1} is a processing result of the output layer.

6. The method of claim 1, wherein the target part is a link transmission mechanism including a first rotation arm, a swing member driven by a first driving mechanism, a first link member, and a second rotation arm; two ends of the swing member are rotatably connected to the first rotation arm and the first link member, respectively, and an end of the first rotation arm away from the swing member and an end of the first link member away from the swing member are both movably connected to the second rotation arm; the motion parameter of the driving mechanism is a driving angle of the first driving mechanism; and the end pose is a posture angle of the second rotation arm.

7. The method of claim 6, wherein the inverse kinematics function relationship is as an equation of:
converting a processing process of the input layer into the matrix expression as equations of:
$$θ = arcsin ( \frac{bc + \sqrt{{b}^{2} {c}^{2} - ( {a}^{2} + {b}^{2} ) ( {c}^{2} - {a}^{2} )}}{{a}^{2} + {b}^{2}} ) + {θ}_{0} ;$$
$$a = {x}_{A} - {x}_{C} ;$$
$$b = {z}_{A} - {z}_{C} ;$$
$$and c = \frac{{l}_{BC}^{2} - {l}_{AB}^{2} - {‖ {R}_{y} ( {θ}_{oy} ) {R}_{x} ( {θ}_{ox} ) \vec{{r}_{C 0}} - \vec{{r}_{A 0}} ‖}^{2}}{2 {l}_{AB}} .$$
where, θₒₓ is a posture angle of the second rotation arm around a preset x-axis, θ_{oy} is a posture angle of the second rotation arm around a preset y-axis, Rₓ(θₒₓ) is a corresponding rotation matrix of rotating at the posture angle θₒₓ around the x-axis, R_{y}(θ_{oy}) is a corresponding rotation matrix of rotating at the posture angle θ_{oy} around the y-axis, A is a connection point between the first driving mechanism and the swing member, B is a connection point between the first link member and the swing member, and C is a connection point between the first link member and the second rotation arm, x_{A} is a coordinate component of the point A on the x-axis, z_{A} is a coordinate component of the point A on a preset z-axis, x_{C} is a coordinate component of the point C on the x-axis, z_{C} is a coordinate component of the point C on the z-axis, l_{AB} is a length from the point A to the point B, l_{BC} is a length from the point B to the point C, θ₀ is an initial included angle between the swing member and a horizontal plane, \vec{r_{A0}} is an initial position vector of the point A, \vec{r_{C0}} is an initial position vector of the point C, and θ is a driving angle of the first driving mechanism.

8. A non-transitory computer-readable storage medium for storing one or more computer programs, wherein the one or more computer programs comprise:
instructions for obtaining a motion parameter of a driving mechanism of a target part of the robot, wherein the motion parameter of the driving mechanism is a driving angle of the driving mechanism of the target part;
instructions for obtaining an end pose of the target part by processing the motion parameter of the driving mechanism according to a preset forward kinematics solving model, wherein the end pose is a posture angle of a rotation arm of the target part, and the forward kinematics solving model is a neural network model trained by a preset training sample set constructed according to a preset inverse kinematics function relationship; and
instructions for controlling the target part of the robot to move based on the end pose.

9. The storage medium of claim 8, wherein the forward kinematics solving model is trained by:
determining a range of the end pose of the target part;
obtaining a first amount of sampling points of the end pose by sampling within the range of the end pose;
calculating the motion parameter of the driving mechanism corresponding to each of the sampling points of the end pose according to the preset inverse kinematics function relationship;
constructing the preset training sample set, wherein the training sample set includes the first amount of training samples, each of the training samples includes a set of the sampling points of the end pose and the corresponding motion parameters of the driving mechanism; and
training the neural network model in an initial state using the preset training sample set, and using the trained neural network model as the forward kinematics solving model.

10. The storage medium of claim 8, wherein obtaining the end pose of the target part by processing the motion parameter of the driving mechanism according to the preset forward kinematics solving model comprises:
inputting the motion parameter of the driving mechanism into the forward kinematics solving model for processing to produce an output, and using the output as the end pose of the target part.

11. The storage medium of claim 8, wherein obtaining the end pose of the target part by processing the motion parameter of the driving mechanism according to the preset forward kinematics solving model comprises:
converting the forward kinematics solving model into a matrix expression; and
substituting the motion parameter of the driving mechanism into the matrix expression for calculation to obtain an operation result, and using the operation result as the end pose of the target part.

12. The storage medium of claim 11, wherein the forward kinematics solving model includes an input layer, a hidden layer, and an output layer; converting the forward kinematics solving model into the matrix expression comprises:
converting a processing process of the input layer into the matrix expression as an equation of:
A_{P×1}=[a₁a₂ . . . aₚ . . . a_{P}]^{T}, aₚ=(θₚ+xₚ)×gₚ−yₚ;
where, p is a sequence number of the motion parameter of the driving mechanism, 1≤p≤P, P is an amount of the motion parameters of the driving mechanism, θₚ is the p-th motion parameter of the driving mechanism, xₚ, gₚ, and yₚ are processing parameters of the input layer in the positive kinematics solving model that correspond to the motion parameter θₚ, the aₚ is a processing result of the input layer that corresponds to the motion parameter θₚ, and A_{P×1} are processing results of the input layer;
converting a processing process from the input layer to the hidden layer into the matrix expression as an equation of:
C_{N×1}=B_{N×1}+W_{N×P}·A_{P×1};
where, N is an amount of neurons in the hidden layer, W_{N×P} is a first weight matrix in the forward kinematics solving model, B_{N×1} is a first bias matrix in the forward kinematics solving model, and C_{N×1} is a processing result from the input layer to the hidden layer;
converting a processing process of the hidden layer into the matrix expression as an equation of:
$${D}_{N \times 1} = \frac{2}{[ 1 + exp ( - 2 \times {C}_{N \times 1} ) ]} - 1 ;$$
where exp is a natural exponential function, and D_{N×1} is a processing result of the hidden layer;
converting a processing process from the hidden layer to the output layer into the matrix expression as an equation of:
E_{Q×1}=B′_{Q×1}+W′_{Q×N}·D_{N×1}=[e₁e₂ . . . e_{q} . . . e_{Q}]^{T};
where, q is a parameter sequence number of the end pose, 1≤q≤Q, Q is a parameter amount of the end pose, W′_{Q×N} is a second weight matrix in the forward kinematics solving model, B′_{Q×1} is a second bias matrix in the forward kinematics solving model, E_{Q×1} is a processing result from the hidden layer to the output layer, and e_{q} is the q-th element in the processing result E_{Q×1}; and
converting a processing process of the output layer into the matrix expression as an equation of:
$${F}_{Q \times 1} = {[ {θ}_{o 1} {θ}_{o 2} … {θ}_{oq} … {θ}_{oQ} ]}^{T} , {θ}_{oq} = \frac{( {e}_{q} - {y}_{q}^{′} )}{{g}_{q}^{′}} + {x}_{q}^{′} ;$$
where, θ_{oq} is the q-th parameter of the end pose, x′_{q}, g′_{q}, and y′_{q} are processing parameters of the output layer in the positive kinematics solving model that correspond to the parameter θ_{oq}, and F_{Q×1} is a processing result of the output layer.

13. The storage medium of claim 8, wherein the target part is a link transmission mechanism including a first rotation arm, a swing member driven by a first driving mechanism, a first link member, and a second rotation arm, two ends of the swing member are rotatably connected to the first rotation arm and the first link member, respectively, and an end of the first rotation arm away from the swing member and an end of the first link member away from the swing member are both movably connected to the second rotation arm; the motion parameter of the driving mechanism is a driving angle of the first driving mechanism; and the end pose is a posture angle of the second rotation arm.

14. A legged robot, comprising:
a processor;
a memory coupled to the processor, and
one or more computer programs stored in the memory and executable on the processor;
wherein, the one or more computer programs comprise:
instructions for obtaining a motion parameter of a driving mechanism of a target part of the robot, wherein the motion parameter of the driving mechanism is a driving angle of the driving mechanism of the target part;
instructions for obtaining an end pose of the target part by processing the motion parameter of the driving mechanism according to a preset forward kinematics solving model, wherein the end pose is a posture angle of a rotation arm of the target part, and the forward kinematics solving model is a neural network model trained by a preset training sample set constructed according to a preset inverse kinematics function relationship; and
instructions for controlling the target part of the robot to move based on the end pose.

15. The robot of claim 14, wherein the forward kinematics solving model is trained by:
determining a range of the end pose of the target part;
obtaining a first amount of sampling points of the end pose by sampling within the range of the end pose;
calculating the motion parameter of the driving mechanism corresponding to each of the sampling points of the end pose according to the preset inverse kinematics function relationship;
constructing the preset training sample set, wherein the training sample set includes the first amount of training samples, each of the training samples includes a set of the sampling points of the end pose and the corresponding motion parameters of the driving mechanism; and
training the neural network model in an initial state using the preset training sample set, and using the trained neural network model as the forward kinematics solving model.

16. The robot of claim 14, wherein obtaining the end pose of the target part by processing the motion parameter of the driving mechanism according to the preset forward kinematics solving model comprises:
inputting the motion parameter of the driving mechanism into the forward kinematics solving model for processing to produce an output, and using the output as the end pose of the target part.

17. The robot of claim 14, wherein obtaining the end pose of the target part by processing the motion parameter of the driving mechanism according to the preset forward kinematics solving model comprises:
converting the forward kinematics solving model into a matrix expression; and
substituting the motion parameter of the driving mechanism into the matrix expression for calculation to obtain an operation result, and using the operation result as the end pose of the target part.

18. The robot of claim 17, wherein the forward kinematics solving model includes an input layer, a hidden layer, and an output layer; converting the forward kinematics solving model into the matrix expression comprises:
converting a processing process of the input layer into the matrix expression as an equation of:
A_{P×1}=[a₁a₂ . . . aₚ . . . a_{P}]^{T}, aₚ=(θₚ+xₚ)×gₚ−yₚ;
where, p is a sequence number of the motion parameter of the driving mechanism, 1≤p≤P, P is an amount of the motion parameters of the driving mechanism, θₚ is the p-th motion parameter of the driving mechanism, xₚ, gₚ, and yₚ are processing parameters of the input layer in the positive kinematics solving model that correspond to the motion parameter θₚ, the aₚ is a processing result of the input layer that corresponds to the motion parameter θₚ, and A_{P×1} are processing results of the input layer;
converting a processing process from the input layer to the hidden layer into the matrix expression as an equation of:
C_{N×1}=B_{N×1}+W_{N×P}·A_{P×1};
where, N is an amount of neurons in the hidden layer, W_{N×P} is a first weight matrix in the forward kinematics solving model, B_{N×1} is a first bias matrix in the forward kinematics solving model, and C_{N×1} is a processing result from the input layer to the hidden layer;
converting a processing process of the hidden layer into the matrix expression as an equation of:
$${D}_{N \times 1} = \frac{2}{[ 1 + exp ( - 2 \times {C}_{N \times 1} ) ]} - 1 ;$$
where exp is a natural exponential function, and D_{N×1} is a processing result of the hidden layer;
converting a processing process from the hidden layer to the output layer into the matrix expression as an equation of:
E_{Q×1}=B′_{Q×1}+W′_{Q×N}·D_{N×1}=[e₁e₂ . . . e_{q} . . . e_{Q}]^{T};
where, q is a parameter sequence number of the end pose, 1≤q≤Q, Q is a parameter amount of the end pose, W′_{Q×N} is a second weight matrix in the forward kinematics solving model, B′_{Q×1} is a second bias matrix in the forward kinematics solving model, E_{Q×1} is a processing result from the hidden layer to the output layer, and e_{q} is the q-th element in the processing result E_{Q×1}; and
converting a processing process of the output layer into the matrix expression as an equation of:
$${F}_{Q \times 1} = {[ {θ}_{o 1} {θ}_{o 2} … {θ}_{oq} … {θ}_{oQ} ]}^{T} , {θ}_{oq} = \frac{( {e}_{q} - {y}_{q}^{′} )}{{g}_{q}^{′}} + {x}_{q}^{′} ;$$
where, θ_{oq} is the q-th parameter of the end pose, x′_{q}, g′_{q}, and y′_{q} are processing parameters of the output layer in the positive kinematics solving model that correspond to the parameter θ_{oq}, and F_{Q×1} is a processing result of the output layer.

19. The robot of claim 14, wherein the target part is a link transmission mechanism including a first rotation arm, a swing member driven by a first driving mechanism, a first link member, and a second rotation arm; two ends of the swing member are rotatably connected to the first rotation arm and the first link member, respectively, and an end of the first rotation arm away from the swing member and an end of the first link member away from the swing member are both movably connected to the second rotation arm; the motion parameter of the driving mechanism is a driving angle of the first driving mechanism; and the end pose is a posture angle of the second rotation arm.

20. The robot of claim 19, wherein the inverse kinematics function relationship is as an equation of:
converting a processing process of the input layer into the matrix expression as equations of:
$$θ = arcsin ( \frac{bc + \sqrt{{b}^{2} {c}^{2} - ( {a}^{2} + {b}^{2} ) ( {c}^{2} - {a}^{2} )}}{{a}^{2} + {b}^{2}} ) + {θ}_{0} ;$$
$$a = {x}_{A} - {x}_{C} ;$$
$$b = {z}_{A} - {z}_{C} ;$$
$$and c = \frac{{l}_{BC}^{2} - {l}_{AB}^{2} - {‖ {R}_{y} ( {θ}_{oy} ) {R}_{x} ( {θ}_{ox} ) \vec{{r}_{C 0}} - \vec{{r}_{A 0}} ‖}^{2}}{2 {l}_{AB}} .$$
where, θₒₓ is a posture angle of the second rotation arm around a preset x-axis, θ_{oy} is a posture angle of the second rotation arm around a preset y-axis, Rₓ(θₒₓ) is a corresponding rotation matrix of rotating at the posture angle θ_{oy} around the x-axis, R_{y}(θ_{oy}) is a corresponding rotation matrix of rotating at the posture angle θ_{oy} around the y-axis, A is a connection point between the first driving mechanism and the swing member, B is a connection point between the first link member and the swing member, and C is a connection point between the first link member and the second rotation arm, x_{A} is a coordinate component of the point A on the x-axis, z_{A} is a coordinate component of the point A on a preset z-axis, x_{C} is a coordinate component of the point C on the x-axis, z_{C} is a coordinate component of the point C on the z-axis, l_{AB} is a length from the point A to the point B, l_{BC} is a length from the point B to the point C, θ₀ is an initial included angle between the swing member and a horizontal plane, \vec{r_{A0}} is an initial position vector of the point A, \vec{r_{C0}} is an initial position vector of the point C, and θ is a driving angle of the first driving mechanism.
